(19) United States
(12) Patent Application Publication
(10) Pub. No.: US 2011/0052159 A1
(43) Pub. Date: Mar. 3, 2011

(54) APPARATUS FOR UNIFORM THERMAL PROCESSING

(76) Inventors: Chiung-Chieh Su, Longtan Township (TW); Meng-Chiuan Yu, Longtan Township (TW); Ming-June Lin, Longtan Township (TW); Yong-Sen Su, Longtan Township (TW)

(21) Appl. No.: 12/553,847

(22) Filed: Sep. 3, 2009

(51) Int. Cl. F26B 3/28

(52) U.S. Cl. 392/411; 392/416

(57) ABSTRACT

An apparatus of thermal processing is provided. A heating lamp and a reflector are disposed over a wafer and the heat flux distribution on the wafer generated by the individual heating lamp is measured and adjusted. A set of heating lamps formed by heating lamps is disposed over the wafer. The heating lamps are in concentric rings and arranged as an axi-symmetric array. The relative position between the set of heating lamps and the wafer is adjusted so that the wafer center is at the position with local mean heat flux from lamps between the most inner lamp subset and its adjacent lamp subset. Followed by adjusting the heating powers, either or both of the wafer and the set of heating lamps are rotated respect to the center of the wafer, so as to improve uniformity of the heat flux distribution on the heated object.

### BACKGROUND OF THE INVENTION

1. Field of the Invention

The present invention relates to an apparatus for a uniform thermal processing and particularly for uniformly heating wafers.

2. Description of the Prior Art

Along with the advances of science and technology and the steady enhancement of living quality plus the continuously growing of computers and the peripheral industries thereof, the IC (integrated circuit) application fields are wider and wider. As to the IC devices in current applications, the silicon wafers are used as the base material for the most IC substrates. On a wafer, a number of semiconductor processes, such as layer deposition, lithographing, etching, removing the photoresist, and followed by packaging and testing, etc. are performed to accomplish the IC device fabrication.

In the above-mentioned semiconductor processes, especially in thermal annealing and thermal oxidizing processes, “temperature” is one of the most important production parameters. A lately developed “rapid thermal processing” (RTP) provides an effective and efficient thermal processing for the wafers. In this thermal processing technology, however, one of the critical issues is how to reach a uniform temperature distribution within a wafer as well as from wafer to wafer.

FIG. 1A is a simplified cross-sectional view, schematically showing a conventional thermal processing apparatus. FIG. 1B is a plan view, schematically showing a set of heating lamps in FIG. 1A. Referring to FIG. 1A and FIG. 1B, a conventional thermal processing apparatus 100 mainly comprises a chamber 110, a supporter 120 and a set of heating lamps 130. Wherein, the supporter 120 and the set of heating lamps 130 are disposed inside the chamber 110 and are separated by a thermally transparent plate 140, such as a quartz plate. The set of heating lamps 130 locates above the supporter 120 and comprises a plurality of heating lamps 132 and reflectors 134. A wafer 10 is placed on the supporter 120. The set of heating lamps 130 is used for heating the wafer 10.

Prior to heating the wafer 10, an individual heating lamp 132 and the appropriate reflector 134 thereof must be adjusted to get a certain heat flux distribution on the wafer 10 to meet the requirements of the conventional thermal processing process. In general, by controlling the distance between the heating lamp 132 and the wafer 10, the shape of the reflector 134 and the heating power applied to the heating lamp 132, a desired contribution by an individual heating lamp 132 on the overall heat flux distribution of the wafer 10 will be obtained. In this way, the individual heating lamp adjustment is completed.

Next, according to the heat flux distribution on the wafer 10 by an individual heating lamp 132, the overall heat flux distribution on the wafer 10 by a set of heating lamps 130 is thus estimated. Since the wafer 10 is in a disk shape, these heating lamps 132 are arranged in an axi-symmetric array to form a set of heating lamps 130 as shown in FIG. 1B. Remarkably, the local area of the wafer 10 right under the heating lamp 132 receives a local maximum heat flux due to the relatively shortest distance between the heat source and the heated spot. On the other hand, the area of the wafer 10 farther away from the heating lamp 132 therefore receives a lower heat flux. Accordingly, it is very hard to meet a uniform requirement of the heat flux distribution on the wafer 10.

To make the heat flux distribution on the wafer 10 uniform, a rotatable design of a supporter 120 with a proper velocity was developed. Thus, the heat flux distribution on wafer 10 along a circumferential direction is relatively uniform. FIG. 2 illustrates the heat flux distribution on a wafer with the rotating supporter in a conventional thermal processing apparatus. In FIG. 2, the chart of heat flux distribution on the wafer 10, the abscissa represents radial positions on the wafer 10 (in unit of cm), the ordinate represents the heat fluxes received on the wafer 10 (in unit of W/cm²), and the zero value of abscissa represents the center of the wafer 10.

Referring to FIG. 1B and FIG. 2, the local area, on the upper surface of wafer 10 and between two adjacent rings of heating lamps 132, is a non-perpendicular incidence zone and the heat flux thereon is relatively lower. Even if the wafer 10 rotates, the accumulated heat density on this non-perpendicular incidence zone is still lower than that on the zone right under the heating lamp 132. The wafer 10 with a proper rotating velocity may get a relatively uniform heat flux distribution along a circumferential direction (P-direction shown in FIG. 1B). Along the radial direction of the wafer 10 (R-direction shown in FIG. 1B), however, the heat flux distribution thereon still has a big fluctuation. As shown in FIG. 2, the fluctuating amplitude is about ±5%. The so-called “fluctuating amplitude” herein means (peak value−average value)/average value.

Thus, excessive fluctuating amplitude of heat flux distribution on a wafer will produce a thermal stress. It may cause dislocation and crossover, i.e. bare wire connection in the IC. In addition, it may also cause a discrepant chemical-reaction rate on the wafer or from wafer to wafer. All those will reduce the production yield of wafers in company with an increased production cost. Along with the tendency of larger-size wafer and tinier-size IC, the problems due to excessive temperature non-uniformity in a wafer would become more serious and worse.

### SUMMARY OF THE INVENTION

The objective of the present invention is to provide a thermal processing apparatus suitable for uniformly heating wafers to increase the production yield of wafers with reduced production cost.

The present invention provides a thermal processing apparatus suitable for heating an object. The thermal processing apparatus comprises a chamber, a rotatable supporter and a set of beating lamps. Wherein, the rotatable supporter is disposed inside the chamber, the heated object is placed on the rotatable supporter and the set of heating lamps is disposed inside the chamber and over the rotatable supporter. The set of heating lamps comprise a plurality of heating lamps, which are arranged as an axi-symmetric array of a plurality of concentric rings. The above-mentioned concentric rings are arranged with appropriate intervals. The rotation center of the heated object is shifted from the concentric rings' center by an offset, a determined vector, so that the object center is at the position with local mean heat flux from lamps between the most inner lamp subset and its adjacent lamp subset. In other words, the center of the rings of heating lamps and the rotation center of heated object are not at the same position. Adjusting the offset, the local areas of the heated object may pass through the position right under the ring of lamps with local maximum irradiance, and then pass through the position between two adjacent rings of lamps with local minimum irradiance, and eventually will be back to its original position. This phenomenon should occur at least once per revolution. The improvement of uniform irradiance on the heated object can thus be achieved.

The present invention further provides another thermal processing apparatus suitable for heating a heated object. The thermal processing apparatus comprises a chamber, a supporter and a rotatable set of heating lamps. Wherein, the supporter is disposed inside the chamber, the heated object is placed on the supporter and the rotatable set of heating lamps is disposed inside the chamber and above the supporter. The rotatable set of heating lamps comprises a plurality of heating lamps, which are arranged as an axi-symmetric array of a plurality of concentric rings. The above-mentioned concentric rings are arranged with an appropriate interval between adjacent two concentric rings. The rotatable set of heating lamps has an array center. The center of heated object is shifted from the center of concentric rings by an offset, which is a determined vector. For heating the object, the set of heating lamps rotates not about its own centers but about the center of the heated object. Adjusting the offset, the local areas of the heated object may pass through the position right under the ring of lamps with local maximum irradiance, and then pass through the position between two adjacent rings of lamps with local minimum irradiance, and eventually will be back to its original position. This phenomenon should occur at least once per revolution. The improvement of uniform irradiance on the heated object can thus be achieved. In general, the rotary one may be the set of lamps or the heated body or the both as well.

According to the thermal processing apparatus in an embodiment of the present invention, the heated object is, for example, a disk-like object such as a wafer, and the heating lamps are, for example, arranged in several concentric rings. Besides, the number of the concentric rings is preferable 6, wherein the first one is a single heating lamp at the center. The intervals between each two adjacent concentric rings from inner to outer are preferably in an interval ratio of 4/3:1.5:2:2:2. If the offset distance is denoted by e, then, the distance between the first ring and the second ring is L1=4e/3. The distance between the second ring and the third ring is L2=1.5e. The distance between the third ring and the fourth ring is L3=2e. The distance between the fourth ring and the fifth ring is L4=2e. The distance between the fifth ring and the sixth ring is L5=2e. If the diameter of the heated object is D, the offset distance e can be calculated by a formula,

$$D / 2 = {\sum }_{i = 1}^{5} Li - e - X .$$

In general, the value of X is 0.3 cm and it is the design tolerance because of no chip fabricated at the outer edge of a wafer.

According to the thermal processing apparatus in an embodiment of the present invention, the offset angle is 15° as shown in FIG. 3C. When D=30 cm, the powers for the first set of heating lamps through the sixth set are in the ratio of 31:36:57:71:65:99, respectively.

According to the thermal processing apparatus in an embodiment of the present invention, the supporter is a wafer supporter.

In the above-described apparatus for thermal processing of the present invention, the following novel measures are applied. At first, the heat flux distribution generated by an individual heating lamp is obtained by, for example, measurement. Selecting a proper arrangement of the set of heating lamps, the appropriate intervals between two concentric rings of heating lamps are subsequently determined. Finally the offset between the center of the heated object and the center of the set of heating lamps, and the heating powers for the rings of the heating lamps are adjusted and controlled. Due to relative eccentric rotation of the set of heating lamps with respect to the center of heated object and, an improvement in uniformity for the heat flux distribution on the surface of the heated object can be effectively achieved.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a schematic cross-sectional view of a conventional thermal processing apparatus.

FIG. 1B is a schematic plan view of the set of heating lamps in FIG. 1A.

FIG. 2 schematically illustrates a heat flux distribution on a wafer after the rotating process in a conventional thermal processing apparatus.

FIG. 3A is a schematic cross-sectional view, schematically illustrating a thermal processing apparatus according to the first embodiment of the present invention.

FIG. 3B is a drawing, schematically showing a partial plan view of the set of heating lamps in FIG. 3A.

FIG. 3C is a drawing, schematically showing a partial plan view of the relative position between the set of heating lamps and the heated object with offset in FIG. 3A.

FIG. 3D is a drawing, schematically showing a partial plan view of the set of heating lamps with intervals between two adjacent rings of heating lamps in FIG. 3A.

FIG. 4 is a cross-sectional view, schematically illustrating a thermal processing apparatus according to a second embodiment of the present invention.

FIG. 5 is a cross-sectional view, schematically illustrating a thermal processing apparatus according to a third embodiment of the present invention.

FIG. 6 illustrates a heat flux distribution of a rotating wafer with offset in a thermal processing apparatus of the first embodiment.

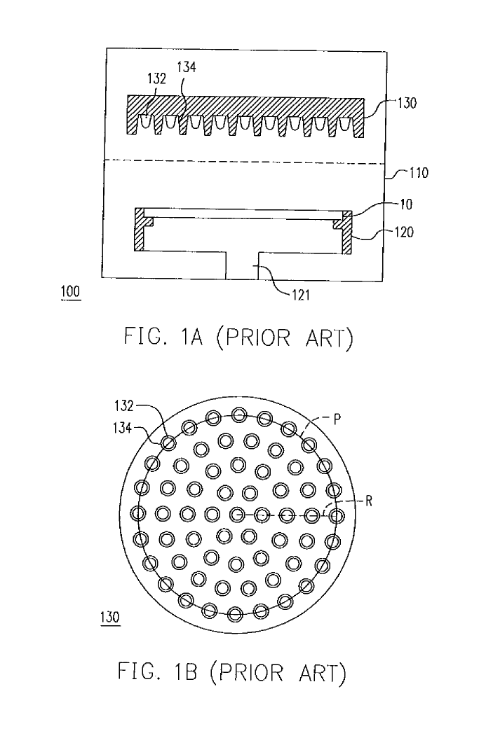

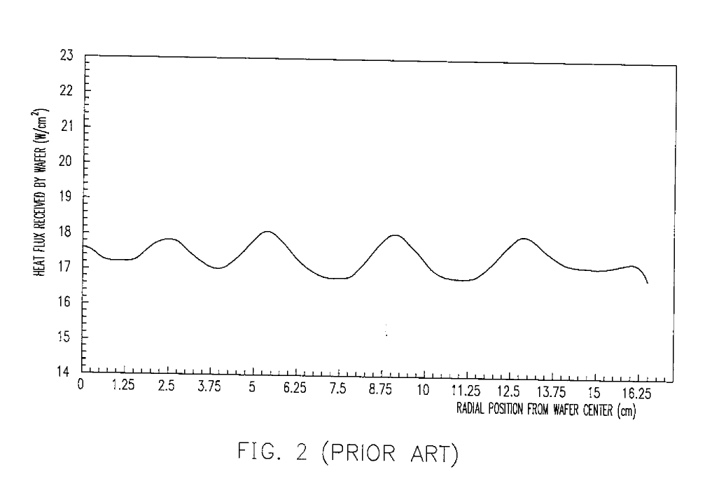

### DETAILED DESCRIPTION OF THE INVENTION

### The First Embodiment

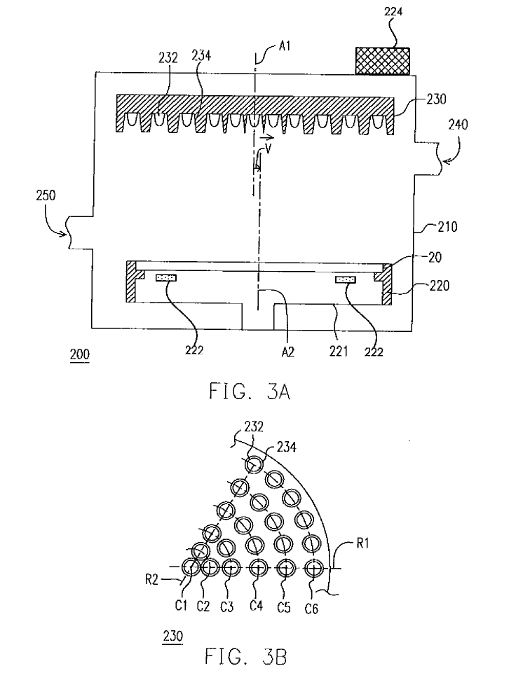

FIG. 3A is a schematic cross-sectional view of a thermal processing apparatus in the first embodiment of the present invention. FIG. 3B is a drawing, schematically showing a partial plan view of the set of heating lamps in FIG. 3A. Referring to FIGS. 3A and 3B, a thermal processing apparatus 200 of the present invention comprises, for example, a chamber 210, a rotatable supporter 220, a set of heating lamps 230, a gas intake 240 and an exhaust outlet 250. Wherein, the rotatable supporter 220, such as a wafer supporter, and the set of heating lamps 230 are disposed inside the chamber 210, and the set of heating lamps 230 is located over the rotatable supporter 220.

The centerline A2 of object 20 is parallel to the array centerline Al of the set of heating lamps 230. The set of heating lamps 230 comprises a plurality of heating lamps 232 and reflectors 234, and the heating lamps 232 are, for example, infrared halogen lamps. A heated object 20 is placed on the rotatable supporter 220 and heated by the set of heating lamps 230. In the embodiment, the heated object 20 is, for example, a disk-like wafer.

For conveniently controlling the set of heating lamps 230 that formed by a plurality of the heating lamps 232 and the reflectors 234 to generate a desired heat flux distribution on the heated object 20, the heating lamps 232 are installed in, for example, a cone-shaped reflectors 234, and the set of heating lamps 230 is, for example, disk-like (or short cylinder-like). The gas intake 240 and the exhaust outlet 250 are disposed at both sides of the chamber 210, respectively. Wherein, the gas intake 240 is used for inputting a reaction gas needed in a semiconductor process, and the exhaust outlet 250 is used for exhausting out the reacted gas.

Referring to FIGS. 3A and 3B, an adjusting technology for the present invention comprises, for example, several steps as follows. Adjusting the individual heating lamp 232 together with the reflector 234 thereof, the heat flux distribution on the heated object 20 generated by an individual heating lamp is obtained by measurement.

To get the required overall heat flux distribution on the heated object 20 generated by a plurality of individual heating lamps 232 together with the reflectors 234 thereof a numerical analysis by superposition method is performed. Wherein, the calculation step is conducted with experimentation.

Next, the heated object 20 is placed in the above-described thermal processing apparatus 200. Wherein, the set of heating lamps 230 is formed by a plurality of the individual heating lamps 232. The heated object 20 is, for example, a disk-like wafer. For 30 cm^{φ} heated object and 1.58 cm^{φ} heating lamps, a set of heating lamps 232 is axi-symmetrically arranged, for example, as six concentric rings, C1, C2, C3, C4, C5 and C6. The C1 is usually formed from a single lamp as a center. The intervals between two adjacent concentric rings are in a ratio of, for example, 4/3:1.5:2:2:2 from the inner to the outer. In the embodiment, the ring C1 is the center of the set of heating lamps 230. The radial lines R1 and R2 are the diameter extension lines of the set of heating lamps.

Furthermore, as shown in FIG. 3A, the thermal processing apparatus 200 of the present invention further includes temperature sensors 222 and a power member 224. The temperature sensors 222 can be used to measure the local temperatures of the heated object 20 where the irradiance primarily from one subset of the heating lamps. The power member 224 is used for applying heating powers to the subsets of the heating lamps according to the temperature feedback of the heated object 20.

FIG. 3C is a drawing, schematically showing a partial plan view of the set of heating lamps 230 with the relative position of the heated object in FIG. 3A. Referring to FIGS. 3A and 3C and the above-described steps, the disposition of the set of heating lamps 230 and the heated object 20 are adjusted so that a desired horizontal offset, represented by a vector V, between the array centerline A1 of the set of heating lamps 230 (i.e. the center of the ring C1) and the centerline A2 of the rotatable object 20 is obtained. Wherein, the offset V is with a directional angle θ, for example 15°, and an offset distance e.

FIG. 3D is a drawing, schematically showing a partial plan view of the set of heating lamps with intervals between two adjacent rings of heating lamps in FIG. 3A. Referring to FIGS. 3A and 3D, since the offset distance is denoted by c, then the distance between the ring C1 and the ring C2 is L1=4e/3, the distance between the ring C2 and the ring C3 is L2=1.5 Se, the distance between the ring C3 and the ring C4 is L3=2e, the distance between the ring C4 and the ring C5 is L4=2e and the distance between the ring C5 and the ring C6 is L5=2e. If the diameter of the heated object 20 is D, the offset distance e can be calculated by a formula,

$$D / 2 = {\sum }_{i = 1}^{5} Li - e - X .$$

In general, the value of X is 0.3 cm and it is the design tolerance because of no chip fabricated at the outer edge of a wafer.

Referring to FIGS. 3A and 3B, after the above-described steps, by adjusting the heating powers, the rings C1, C2, C3, C4, C5 and C6 of heating lamps 232 are with various power ratios respectively. Wherein, if D=30 cm the power ratios are 31:36:57:71:65:99. Moreover, the powers for the rings C1, C2, C3, C4, C5 and C6 can be controlled by, for example, PID (proportional integration differentiation) mode. Then, the heated object 20 rotates around the centerline thereof. This is equivalent to that the set of heating lamps 230 eccentrically rotates relatively to the heated object 20 due to the effect from the offset V. Referring to FIG. 3C, by adjusting the offset V, the local areas of the heated object 20 can preferably pass regions of local maximum irradiance (shown as the position b in FIG. 3C) and local minimum irradiance (shown as the position a in FIG. 3C) during rotation. In comparison with the conventional thermal processing apparatus 100, in the thermal processing apparatus 200 of the present invention, the heated object 20 rotates with an offset in a constant velocity. Besides, the ratios of intervals between adjacent concentric rings and the heating powers of the rings of heating lamps 232 are adjusted. In this way, the heated object 20 in the thermal processing apparatus of the present invention is able to receive uniform heat fluxes from the set of heating lamps 230.

### The Second Embodiment

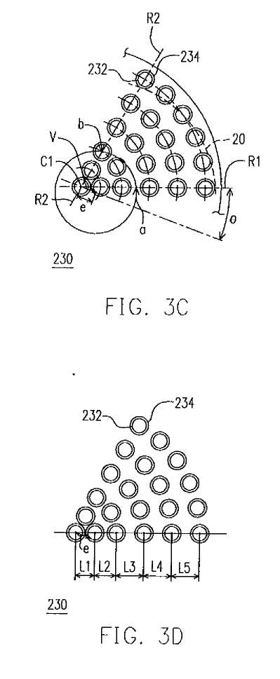

FIG. 4 is a cross-sectional view, schematically illustrating a thermal processing apparatus according to a second embodiment of the present invention. Unlike the above-described thermal processing apparatus 200 in the first embodiment, the set of heating lamps of the thermal processing apparatus 300 in the second embodiment is rotatable, and the supporter 320 of the thermal processing apparatus 300 is not rotated. Remarkably, the offset V is also arranged. The set of heating lamps 330 rotates eccentrically around the centerline B2 of the heated object. This is equivalent to that the heated object 20 rotates about the centerline B2 thereof and with an offset as shown in the first Embodiment. As to the other components and the relative positions thereof of the thermal processing apparatus 300 are the same as those in the first embodiment, so descriptions for the other components are omitted for simplicity. In the same way as the first embodiment of the present invention, the heated object 20 receives a uniform heat flux from the rotating set of heating lamps 330 by adjusting the ratio of interval between rings, the offset distance e, the offset angle θ and the heating powers of the rings of heating lamps 332.

### The Third Embodiment

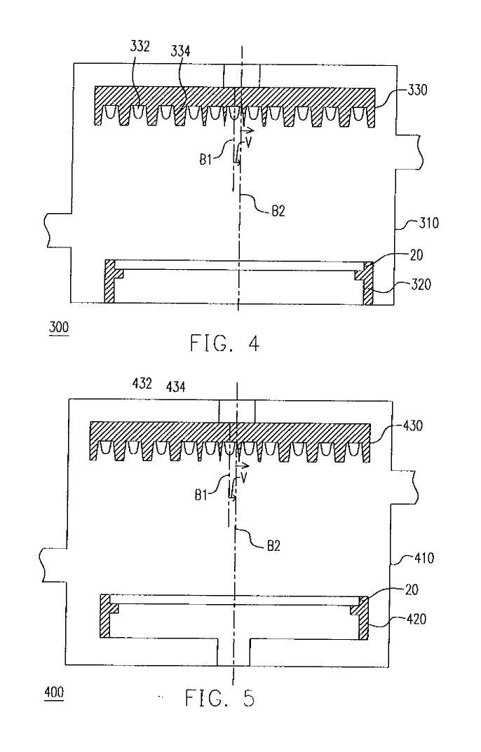

FIG. 5 is a schematic section view of a thermal processing apparatus in the third embodiment of the present invention. Unlike the above-described thermal processing apparatus 200 in the first embodiment, the set of heating lamps of the thermal processing apparatus 400 in the third embodiment is also rotatable. In other words, both the set of heating lamps 430 and the heated objected 20 are all in rotation. One possibility is that the heated object 20 rotates about the centerline B2 thereof and the set of heating lamps 430 rotates eccentrically about the centerline B2 of heated object 20 as well. As a result, a relative eccentric rotation of the heated objected 20 with respect to the set of heating lamps 430 is achieved. As to the other components and the relative positions thereof of the thermal processing apparatus 400 are the same as those in the first embodiment, so the descriptions of the other components are omitted for simplicity. In the same way as the first embodiment of the present invention, the heated object 20 receives a uniform heat flux from the relatively rotating set of heating lamps 430 by adjusting the ratio of interval between concentric rings, the offset distance e, the offset angle θ and the heating powers of the rings of heating lamps 432.

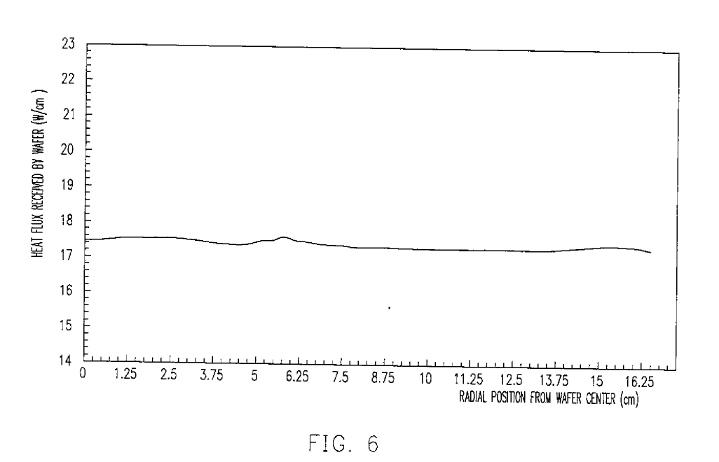

A heat flux distribution under the eccentric rotation according to the present invention is shown in FIG. 6. It schematically illustrates the heat flux distribution on a wafer after the eccentrically rotating in a thermal processing apparatus of the first embodiment. In FIG. 6, the abscissa represents radial position on a wafer (in unit of cm), the ordinate represents the received heat flux on the wafer (in unit of W/cm²), and the zero value of the abscissa represents the center position of the heated object 20 (for example, the wafer).

Referring to FIGS. 3A and 6, the heated object 20 is a disk-like wafer with a diameter of, for example, 30 cm and each heating lamp 232 has a diameter of 1.58 cm. The heating lamps are located at six concentric rings, C1, C2, C3, C4, C5 and C6, to form the set of heating lamps 230 with six subsets. The subsets are the rings of heating lamps and with the intervals of L1=4e/3, L2=1.5e, L3=2e, L4=2e and L5=2e. Taking the offset angle θ=15°, the offset distance e can be calculated from the formula

$$D / 2 = {\sum }_{i = 1}^{5} Li - e - X = 0.7833 e - 0.3$$

(in unit of cm) to get e=1.953 cm. After setting the offset distance e, the heating powers are also adjusted subsequently. The heating power applied to each heating lamp at the same concentric ring is basically the same. For D=30 cm, and six concentric rings, the heating powers applied to the individual concentric ring are in a ratio of 31:36:57:71:65:99, respectively. In the process with the above-described adjustments, a generated heat flux distribution is obtained in FIG. 6. It indicates that the adjusting technology and the apparatus for thermal processing of the present invention are very effectively to obtain a uniform heat flux distribution on a heated object 20 (for example, a wafer). As shown in FIG. 6, the fluctuating amplitude of heat flux distribution on the heated object 20 is reduced from ±5% to only about ±0.5%. The so-called “fluctuating amplitude” herein means (peak value−average value)/average value.

Since the relative rotation between the heated object 200 and the set of heating lamps 330 in 2^{nd} embodiment and the 3^{rd} embodiment are similar to that in the 1^{st} embodiment, the efficiencies similar to that in the first embodiment are verified for the thermal processing apparatus 300 in the second embodiment and the thermal processing apparatus 400 in the third embodiment. That is, the fluctuating amplitude of heat flux distribution on the heated object 20 may be reduced quite much as well.

Remarkably, the object shape to be heated in the apparatus for thermal processing of the present invention is not limited to a disk-like shape; it can have other shapes. Further, the heated object is not limited to a wafer; it can be other suitable material to be heated. Therefore, the apparatus for thermal processing of the present invention are not limited to the semiconductor processes; they are suitable for thermal processes of other material as well. In addition, the number of the rings of heating lamps is determined by the diameter of heating lamps and the size of the heated object. Thus, the number of the rings of heating lamps is not limited to “six” only, it can be other numbers (for example, a number larger or smaller than six). The ratio of ring interval corresponding to the heating lamps accordingly is 4/3:1.5:2:2:2:2 . . . 2, wherein “ . . . ” represents “2”. Besides, the set of heating lamps in the apparatus for thermal processing of the present invention is not limited to be disposed at one side of a heated object only; it can be two sets and disposed at both sides of a heated object, respectively. All these alternatives still belong to the scope protected by the present invention.

To sum up, the apparatus for thermal processing of the present invention is distinguished from the conventional thermal processing apparatuses by the following features. Firstly, the heat flux distribution generated by an individual heating lamp is obtained by, for example, measurement. Secondly, a proper arrangement of the set of heating lamps is selected and adjusted. Thirdly, the offset between the center of the heated object and the center of the set of heating lamps is adjusted. Due to this offset, the heated object and the set of heating lamps are relatively moved in a way of eccentric rotation.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A thermal processing apparatus, suitable for heating an object having an object center, comprising:
a chamber;
a supporter located inside the chamber, and the object being disposed on the supporter;
a set of heating lamps, having a lamp center, disposed inside the chamber and over the supporter, wherein the set of the heating lamps comprises a plurality of heating lamps arranged in a plurality of subsets respectively forming a plurality of radially-spaced concentric rings, wherein the object center and the lamp center are shifted by an offset e such that the object center is at the position with local mean heat flux from lamps between the most inner lamp subset and its adjacent lamp subset; and
a rotation member, which is either or both of the heated object and the set of heating lamps so as to have an equivalent eccentric rotation such that the local areas of the heated object may pass through the position right under the ring of lamps with local maximum irradiance, and then pass through the position between two adjacent rings of lamps with local minimum irradiance.

2. The thermal processing apparatus as recited in claim 1, wherein a shape of the heated object comprises a disk shape.

3. The thermal processing apparatus as recited in claim 1, wherein the heated object comprises a wafer.

4. The thermal processing apparatus as recited in claim 1, wherein the number of the subsets of the heating lamps is six.

5. The thermal processing apparatus as recited in claim 4, wherein the subsets of the heating lamps are arranged into a plurality of concentric rings with intervals between the subsets by a ratio of 4/3:1.5:2:2:2.

6. The thermal processing apparatus as recited in claim 5, wherein an offset distance of the offset is denoted as e and the concentric subsets of the heating lamps comprise a first ring, a second ring, a third ring, a fourth ring, a fifth ring and a sixth ring, in which the interval between the first ring and the second ring is L₁=4e/3, the interval between the second ring and the third ring is L₂=1.5e, the interval between the third ring and the fourth ring is L₃=2e, the interval between the fourth ring and the fifth ring is L₄=2e, and the interval between the fifth ring and the sixth ring is L₅=2e.

7. The thermal processing apparatus as recited in claim 6, wherein a diameter of the heated object is denoted as D and the offset distance e is calculated by a formula of
$$D / 2 = {\sum }_{i = 1}^{5} Li - e - X ;$$
wherein X is a constant indicating an unintended region of the heated object at a brim region.

8. The thermal processing apparatus as recited in claim 7, wherein the value of X is 0.3 cm and the value of D is 30 cm.

9. The thermal processing apparatus as recited in claim 4, wherein an angle of the offset away from a reference direction is 15°.

10. The thermal processing apparatus as recited in claim 4, further comprising a power member for applying heating powers to the subsets of the heating lamps by a ratio of 31:36:57:71.65:99.

11. The thermal processing apparatus as recited in claim 1, wherein the number of the subsets of the heating lamps is n, and the subsets of the heating lamps comprises a most inner subset with single one of the heating lamps at the lamp center.

12. The thermal processing apparatus as recited in claim 11, wherein the subsets of the heating lamps are arranged into a plurality of concentric rings with intervals Li between e and 2e.

13. The thermal processing apparatus as recited in claim 12, wherein a diameter of the heated object is denoted as D and the offset distance e is calculated by a formula of
$$D / 2 = {\sum }_{i = 1}^{n - 1} {L}_{i} - e - X ,$$
wherein the X is a constant indicating an unintended region of the heated object at a brim region.

14. The thermal processing apparatus as recited in claim 11, further comprising a power member for applying heating powers to the subsets of the heating lamps according to the temperature feedback of the heated object.

15. The thermal processing apparatus as recited in claim 14, the temperature sensors installed to measure the local temperatures of heated object where the irradiance primarily from one subset of the heating lamps.

16. The thermal processing apparatus as recited in claim 11, wherein two sets of heating lamps disposed at both sides of the heated object.
